(19) United States
(12) Patent Application Publication
(10) Pub. No.: US 2010/0019699 A1
(43) Pub. Date: Jan. 28, 2010

(54) LAPTOP MIRROR

(76) Inventors: JOHN RAY MCBRIDE, Reeds Spring, MO (US); Cherilyn Korth, Reeds Spring, MO (US)

Correspondence Address: James Ray & Associates, 2640 Pitcairn Road, Monroeville, PA, 15146, US

(21) Appl. No.: 12/508,217

(22) Filed: Jul. 23, 2009

Related U.S. Application Data
(60) Provisional application No. 61/135,748, filed on Jul. 23, 2008.

(51) Int. Cl. H05B 37/02; F21V 33/00; F21L 4/00

(52) U.S. Cl. 315/362; 362/135; 362/190

(57) ABSTRACT

The present invention in several embodiments is a clip-on mirror accessory for laptop computers. The present invention in several embodiments is a rotatable mirror device that can be easily affixed to the screen of a laptop to easily view one's face and surroundings. This device can assist users in viewing the area behind their back while typing. This can be especially beneficial for users that may be working on confidential materials. The present invention can also assist users in checking their hair, makeup and teeth.

### CROSS REFERENCE TO RELATED APPLICATION

This patent application is related to and claims priority from U.S. Provisional Patent Application Ser. No. 61/135,748 filed Jul. 23, 2008.

### FIELD OF THE INVENTION

This invention generally pertains to mirrors and laptop computer accessories. The present invention is particularly applicable to detachable and reattachable laptop mirrors and accessories.

### BACKGROUND OF THE INVENTION

While working on a laptop in a public area, one may feel self-conscious or nervous about others having the ability to view their screen or confidential materials. Being able to look at what is happening behind them may make some users feel more secure. Also, if using a laptop before a meeting, a person may have to make an extra stop to look at themselves in the mirror. One may also have something painfully in their eye that they would need to view in order to remove.

Accordingly, it has been considered desirable to develop a new and improved mirror which would overcome the foregoing difficulties and others while providing better and more advantageous overall results.

### SUMMARY OF THE INVENTION

The present invention in several embodiments is a clip-on mirror accessory for laptop computers. The present invention in several embodiments is a rotatable mirror device that can be easily affixed to the screen of a laptop to easily view one's face and surroundings. This device can assist users in viewing the area behind their back while typing. This can be especially beneficial for users that may be working on confidential materials. The present invention can also assist users in checking their hair, makeup and teeth. The mirror may have an area on the back for a logo. Computer manufacturers and others can then use this as an advertising device. Anyone can use this rotating, lighted device for an easy way to view themselves and their surroundings while using a laptop computer.

In several embodiments the invention is a computer accessory that offers users an easy way to view themselves and their surroundings. This device looks similar to a traditional mirror. The back of the device may be a flat, solid, durable material with an optional logo. The bottom of the device may include a curved clip in order for it to be temporarily attached to the laptop without damaging the computer. Soft rubber may line the inside of the curved clip to provide extra padding to ensure the laptop will not be harmed. There may also be a small button on the corner of the mirror to turn on the light component. This light will allow users to clearly see documents, books, the keyboard or one's face. The button may be flush with the laptop so it will not be accidentally turned on during transport or use. This product may have the ability to turn approximately 180-degrees. This item may measure approximately 3″ high, 3″ long and ¼″ wide.

### OBJECTS OF THE INVENTION

It is therefore one of the primary objects of the present invention to provide a mirror that is attachable and detachable to a laptop computer screen.

Another object of the present invention is to provide a mirror with an integrated light that is attachable and detachable to a laptop computer screen.

Still another object of the present invention is to provide a mirror with an integrated light that is attachable and detachable to a laptop computer screen and can be rotated, tilted and positioned as desired by a user.

In one embodiment the invention is a laptop computer accessory comprising: at least one mirror, at least one laptop screen attachment means, wherein said laptop screen attachment means is detachable and reattachable to a laptop screen. In another embodiment, the laptop computer accessory further comprises an integrated light. In yet another embodiment, the laptop computer accessory further comprises a ball and socket joint for positioning said mirror. In another embodiment, the laptop computer accessory further comprises a revolute joint for positioning said mirror. In another embodiment the at least one laptop screen attachment means comprises at least one rubberized attachment surface.

In still another embodiment the invention is a laptop computer accessory comprising: at least one mirror, at least one light, at least one battery, at least one joint for positioning said mirror, at least one laptop screen attachment means, wherein said laptop screen attachment means is detachable and reattachable to a laptop screen. In another embodiment, said at least one joint for positioning said mirror comprises a ball and socket joint. In yet another embodiment said at least one joint for positioning said mirror comprises; a ball and socket joint, and a revolute joint. In still another embodiment the laptop computer accessory, further comprises an indicator light for indicating a status of said at least one battery. In yet another embodiment, the at least one laptop screen attachment means comprises at least one rubberized attachment surface. In still another embodiment the at least one laptop screen attachment means clips onto said laptop screen by means of at least one rubberized attachment surface.

In yet still another embodiment the invention is a laptop computer accessory comprising: at least one mirror, at least one light emitting diode, at least one battery, at least on switch for controlling said at least one light, at least one joint for positioning said mirror, at least one laptop screen attachment means, wherein said laptop screen attachment means is detachable and reattachable to a laptop screen.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general frontal view drawing of a preferred embodiment of the present invention.

FIG. 2 is a general perspective drawing of a preferred embodiment of the present invention being used on a laptop screen.

FIG. 3 is a perspective drawing of a preferred embodiment of the present invention being used by on a laptop screen while being rotated and tilted.

FIG. 4 is a perspective drawing of a preferred embodiment of the present invention being rotated and showing area for a logo or other design.

FIG. 5 is a perspective drawing of a preferred embodiment of the present invention in a stowed position.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

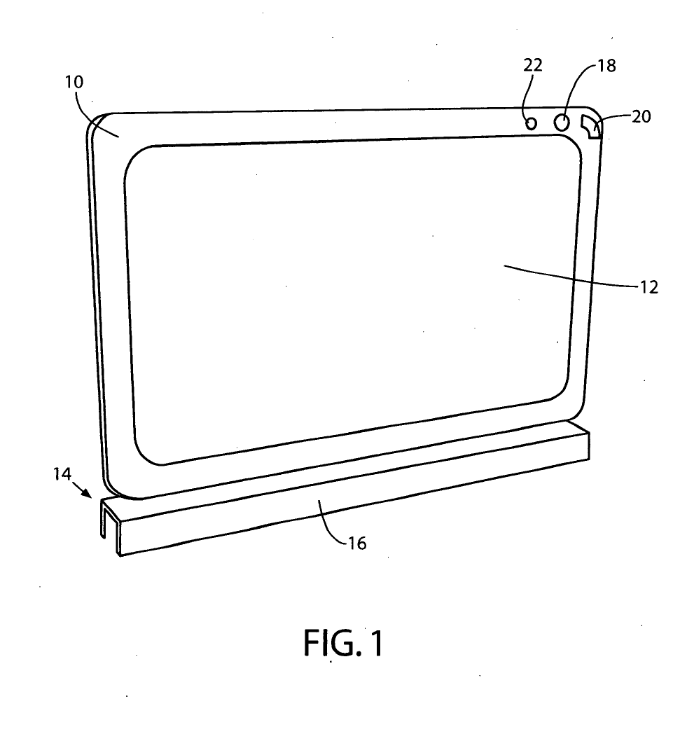

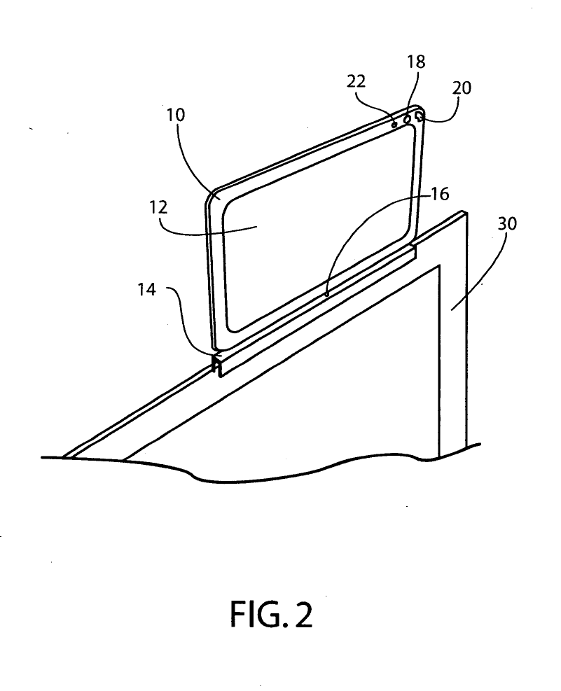

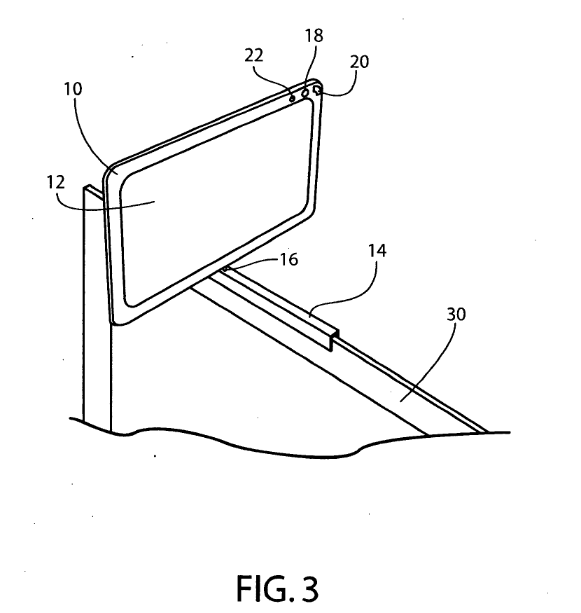

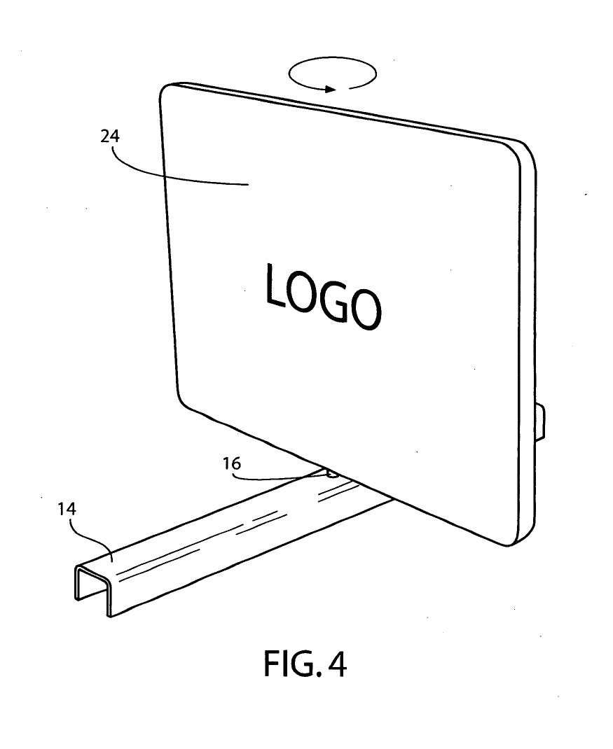

Reference is now made to FIGS. 1-5 which show several views of a preferred embodiment of the present invention. This preferred embodiment comprises mirror frame 10, mirror 12, screen mount 14, positioning joint 16, light 18, light switch 20, indicator light 22 and design placement area 24.

Mirror frame 10 is preferably constructed of a durable plastic or other lightweight durable material. Mirror frame 10 and mirror 12 could be any shape, but for greatest utility it is preferred they are generally rectangular in shape. Mirror 12 could be made of any known reflective material known in the art, for example polished metal, electroplated material or the like. Mirror 12 could also be a curved mirror to produce magnified or diminished images or focus light or simply distort the reflected image. Screen mount 14 is constructed to be detachable and reattachable to a laptop computer screen 30. Preferably, screen mount 14 is a clip with a rubberized portion to protect the laptop's surface as well as provide a secure grip and attachment to the laptop screen 30. Alternatively, screen mount 14 could use other attachment means such as a vise grip type device, a spring load clip, or even adhesives to securely attach the mirror to laptop screen. Though it is preferable that whatever means used allows for detachment and reattachment.

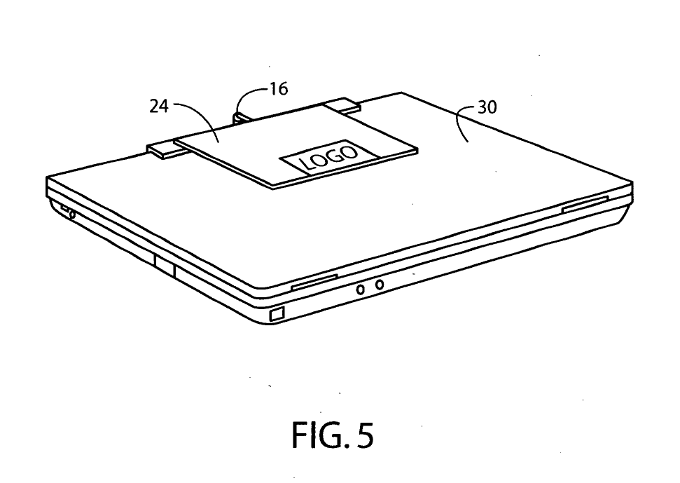

Positioning joint 16 is preferably capable of rotating at least 180 degrees and more preferably capable of rotating 360 degrees. Positioning joint 16 is also preferably capable of tilting at least 180 degrees. In several preferred embodiments positioning joint 16 is capable of tilting at least 270 degrees so that mirror frame 10 and mirror 12 can fold onto the outer surface of a laptop screen as shown in FIG. 5. This position allows for easy laptop handling and protects mirror 12 surface. To accomplish this end, positioning joint 16 could comprise a revolute joint and a ball and socket joint. Of course other means known in the art could also be used.

Light 18 could be constructed as any suitable lighting element known in the art, but preferably comprises at least one light emitting diode (LED). In a preferred embodiment an array of LEDs form light 18. Light switch 20 is preferably a flush mounted two way button, but a three way button could be used to allow for at least two different light levels from light 18. Light switch 20 connects light 18 to an internal battery (not shown). Preferably internal battery is a small long lasting battery, such a Lithium-ion or Lithium-ion polymer battery. Indicator light 22 can be used to monitor the charge on an internal battery (not shown). When the charge level of the internal battery becomes low the light could indicate this state by blinking, turning on or some other method.

Design placement area 24 could be utilized for displaying a logo, trademark, service mark or other design.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A laptop computer accessory comprising: at least one mirror, at least one laptop screen attachment means, wherein said laptop screen attachment means is detachable and reattachable to a laptop screen.

2. The laptop computer accessory of claim 1, further comprising an integrated light.

3. The laptop computer accessory of claim 1, further comprising a ball and socket joint for positioning said mirror.

4. The laptop computer accessory of claim 1, further comprising a revolute joint for positioning said mirror.

5. The laptop computer accessory of claim 1, wherein the at least one laptop screen attachment means comprises at least one rubberized attachment surface.

6. A laptop computer accessory comprising:
at least one mirror,
at least one light,
at least one battery,
at least one joint for positioning said mirror,
at least one laptop screen attachment means, wherein said laptop screen attachment means is detachable and reattachable to a laptop screen.

7. The laptop computer accessory of claim 6, wherein said at least one joint for positioning said mirror comprises a ball and socket joint.

8. The laptop computer accessory of claim 6, wherein said at least one joint for positioning said mirror comprises; a ball and socket joint, and a revolute joint.

9. The laptop computer accessory of claim 6, further comprising an indicator light for indicating a status of said at least one battery.

10. The laptop computer accessory of claim 6, wherein the at least one laptop screen attachment means comprises at least one rubberized attachment surface.

11. The laptop computer accessory of claim 6, wherein the at least one laptop screen attachment means clips onto said laptop screen by means of at least one rubberized attachment surface.

12. A laptop computer accessory comprising:
at least one mirror,
at least one light emitting diode,
at least one battery,
at least on switch for controlling said at least one light,
at least one joint for positioning said mirror,
at least one laptop screen attachment means, wherein said laptop screen attachment means is detachable and reattachable to a laptop screen.
